(19) United States
(12) Patent Application Publication
(10) Pub. No.: US 2017/0344192 A1
(43) Pub. Date: Nov. 30, 2017

(54) METHOD AND DEVICE FOR PLAYING LIVE VIDEOS

(71) Applicant: Beijing Xiaomi Mobile Software Co., Ltd., Beijing (CN)

(72) Inventors: Shuo LIU, Beijing (CN); Xuhua ZHANG, Beijing (CN); Shan YAN, Beijing (CN)

(73) Assignee: Beijing Xiaomi Mobile Software Co., Ltd., Beijing (CN)

(21) Appl. No.: 15/362,111

(22) Filed: Nov. 28, 2016

(30) Foreign Application Priority Data
May 27, 2016 (CN) 201610365891.X

(51) Int. Cl. G06F 3/0481; G06F 3/0484; H04N 5/445; H04N 21/443

(52) U.S. Cl. CPC G06F 3/0481; H04N 21/4438; G06F 3/04845; H04N 5/44591

(57) ABSTRACT

The disclosure relates to a method and device for playing videos. The method includes playing a first video in a video window; receiving a first instruction to switch windows; transferring the first video from the video window to a floating window in response to receiving the first instruction; receiving a second instruction to play a second video; and closing the floating window in response to receiving the second instruction.

### CROSS-REFERENCE TO RELATED APPLICATIONS

The present application is based upon and claims priority to Chinese Patent Application No. 201610365891.X, filed May 27, 2016, the entire contents of which are incorporated herein by reference.

### TECHNICAL FIELD

The present disclosure generally relates to technologies for playing videos, and more particularly, to a method and device for playing videos.

### BACKGROUND

In related arts, people often use video software in mobile phones to watch videos. During the viewing of a video, if a user exits from a video to seek other desired videos, or to perform other operations, the previously played video will stop immediately. The user needs to click again to continue the viewing of the video. That is, the user cannot view video contents while searching videos in a video list, thereby resulting in bad user experience.

### SUMMARY

This Summary is provided to introduce a selection of aspects of the present disclosure in a simplified form that are further described below in the Detailed Description. This Summary is not intended to identify key features or essential features of the claimed subject matter, nor is it intended to be used to limit the scope of the claimed subject matter.

Aspects of the disclosure provide a method for playing videos. The method includes playing a first video in a video window; receiving a first instruction to switch windows; transferring the first video from the video window to a floating window in response to receiving the first instruction; receiving a second instruction to play a second video; and closing the floating window in response to receiving the second instruction. An area of the floating window is smaller than an area of the video window. The video window is a full-screen video window.

The method also includes displaying an operation interface in an area that is not covered by the floating window. The method also includes moving the floating window within an area. Furthermore, the method includes playing the second video in the video window after the floating window is closed. Further still, the method includes receiving a switching operation on the floating window; and transferring the first video from the floating window to the video window.

Aspects of the disclosure also provide a device for playing videos. The device includes a processor and a memory for storing instructions executable by the processor. The processor is configured to play a first video in a video window; transfer the first video from the video window to a floating window in response to receiving the first instruction; receive a second instruction to play a second video; and close the floating window in response to receiving the second instruction. The floating window is smaller than an area of the video window. The video window is a full-screen video window.

The processor is also configured to display an operation interface in an area that is not covered by the floating window. The processor is also configured to move the floating window within an area. Furthermore, the processor is configured to play the second video in the video window after the floating window is closed. Further still the processor is configured to receive a switching operation on the floating window; and transfer the first video from the floating window to the video window.

Aspects of the disclosure also provide a non-transitory computer-readable storage medium having stored therein instructions that, when executed by a processor of a terminal, cause the processor to perform a method for playing videos. The method includes playing a first video in a video window; transferring the first video from the video window to a floating window in response to receiving the first instruction; receiving a second instruction to play a second video; and closing the floating window in response to receiving the second instruction.

It is to be understood that both the foregoing general description and the following detailed description are illustrative and explanatory only and are not restrictive of the present disclosure.

### BRIEF DESCRIPTION OF THE DRAWINGS

The accompanying drawings, which are incorporated in and constitute a part of this specification, illustrate aspects consistent with the disclosure and, together with the description, serve to explain the principles of the disclosure.

FIG. 1 is a flow chart of a method for playing videos according to an exemplary aspect of the present disclosure.

FIG. 2 is a flow chart of a method for playing videos according to an exemplary aspect of the present disclosure.

FIG. 3 is a flow chart of a method for playing videos according to an exemplary aspect of the present disclosure.

FIG. 4 is a flow chart of a method for playing videos according to an exemplary aspect of the present disclosure.

FIG. 5 is a flow chart of a method for playing videos according to an exemplary aspect of the present disclosure.

FIG. 6 is a block diagram of a device for playing videos according to an exemplary aspect of the present disclosure.

FIG. 7 is a block diagram of a switching module in a device for playing videos according to an exemplary aspect of the present disclosure.

FIG. 8 is a block diagram of a device for playing videos according to an exemplary aspect of the present disclosure.

FIG. 9 is a block diagram of a device for playing videos according to an exemplary aspect of the present disclosure.

The specific aspects of the present disclosure, which have been illustrated by the accompanying drawings described above, will be described in detail below. These accompanying drawings and description are not intended to limit the scope of the present disclosure in any manner, but to explain the concept of the present disclosure to those skilled in the art via referencing specific aspects.

### DETAILED DESCRIPTION

Reference will now be made in detail to exemplary aspects, examples of which are illustrated in the accompanying drawings. The following description refers to the accompanying drawings in which the same numbers in different drawings represent the same or similar elements unless otherwise represented. The implementations set forth in the following description of exemplary aspects do not represent all implementations consistent with the disclosure. Instead, they are merely examples of apparatuses and methods consistent with aspects related to the disclosure as recited in the appended claims.

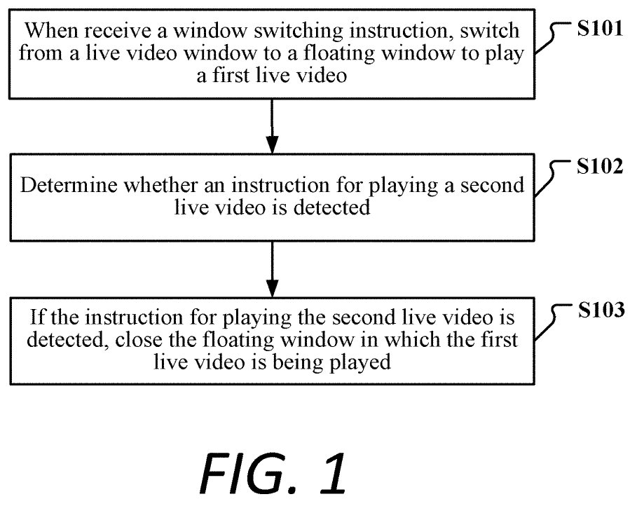

FIG. 1 is a flow chart of a method for playing videos according to an exemplary aspect. The method can be applied in a terminal or a system or program for controlling the terminal.

The method for playing videos in the technical solutions of the present disclosure is intended to meet people's requirements for performing other operations while viewing videos, so as to enable people to perform other operations while viewing videos. The video may be a pre-recorded video, a live stream or broadcast, or any type of video that may be played by a video application. For example, when a user is viewing a video, the video which is being played in a video window on the screen is an example of the first video in aspects of the present disclosure. That is, the first video is the video which is being viewed by the user. At this time, the user may view the video in a full-screen video window, or in a window covering a part of the area of the screen. At this time, if the user needs to perform other operations during the playing of the video, for example, the user may need to find information of other videos, or need to interact with other users, the user may send a window switching instruction by clicking, for example. When the window switching instruction is received, the playing of the first video is switched from the current video window to a floating window, that is, the first video is played in the floating window.

As shown in FIG. 1, the method for playing videos provided by an aspect of the present disclosure can include the following steps S101 to S103.

In S101, when a window switching instruction is received, playing of the first video is switched from a video window to a floating window.

In an aspect, the floating window may be displayed as floating on a screen or page. The floating window is provided on the screen or page. For example, if the previously displayed screen or page is a page for selecting videos, the floating window may be floating on the page and covering a part of the area of the page, without influencing the normal operations and display of the page. The user can continue to perform related operations on the page, and the first video in the floating window is not influenced. The area of the floating window is usually smaller than the area of the screen or the page, that is, smaller than the area of the video window. For example, the area of the floating window may be half of the area of the screen or page or less, and the area of the floating window can be adjusted according to actual requirements.

In S102, whether an instruction for playing a second video is detected is determined.

In an aspect, when the first video is played in the floating window, whether an instruction for playing a second video is received can be monitored in real time. That is, when the user is viewing the video in the floating window, he/she can perform operations unrelated to the video. If the user's operation is clicking another video, i.e., the second video, an instruction for playing the second video is generated.

In S103, on the condition that the instruction for playing the second video is detected, the floating window in which the first video is being played can be closed.

In an aspect, when the instruction for playing the second video is detected, the floating window in which the first video is currently being played can be closed.

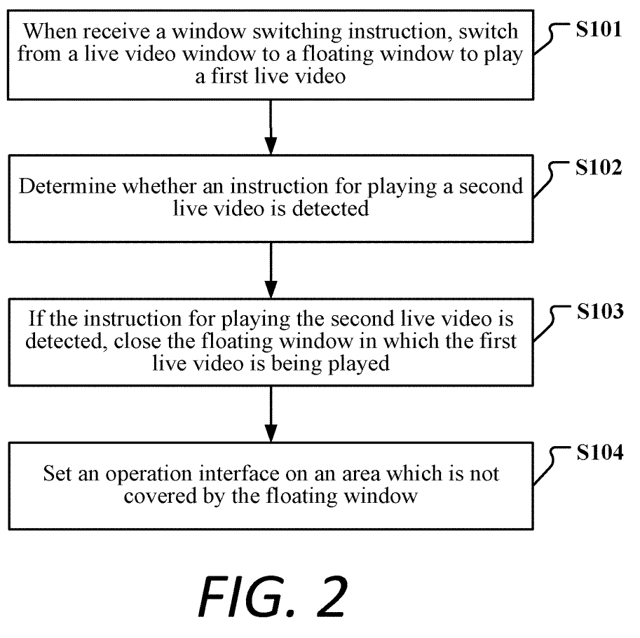

In an aspect, as shown in FIG. 2, the above method for playing videos can further include the following steps.

In S104, an operation interface is set on an area which is not covered by the floating window.

Because of the coverage of the floating window, the area which is covered by the floating window cannot display the contents of the screen or page, but this does not influence the operations on the screen or page. For the area of the screen or page which is not covered, the contents of the screen or page can be displayed normally. According to actual requirements of the screen or page, an operation interface can be set. That is, for the area of the screen or page outside the floating window, the user can perform operations on the screen or page normally, and the playing of the first video is not influenced.

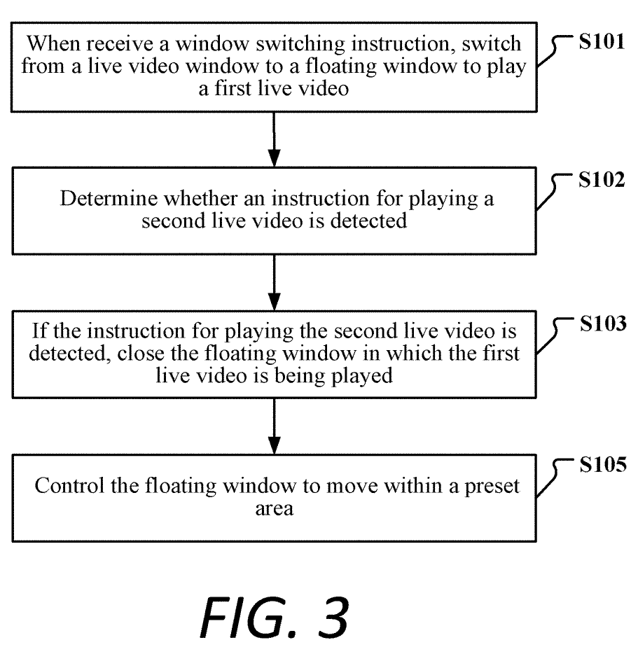

In an aspect, as shown in FIG. 3, the above method for playing videos can further include the following steps.

In S105, the floating window is controlled to move within a preset area.

The floating window can be movable, for example, the floating window can move on the screen or page according to user's requirements. For example, the user can set the position of the floating window on the screen or page according to his/her preference, and can adjust the position of the floating window at any time. Alternatively, the user can change the position of the floating window at any time by dragging, for example.

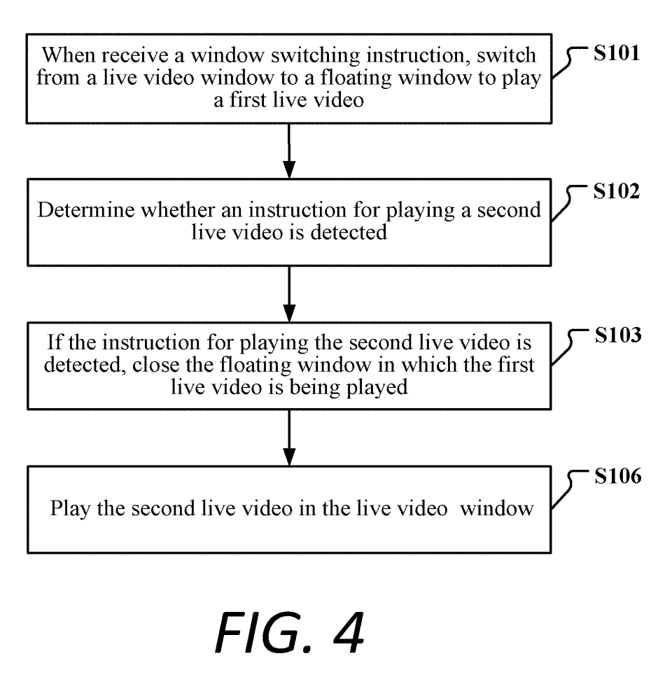

In an aspect, as shown in FIG. 4, the above method for playing videos can further include the following steps.

In S106, the second video is played in the video window.

After the floating window is closed, the second video needs to be played. At this time, the playing can be performed in the video window. For example, the second video can be played in a full-screen video window or in a video window previously presented on the page. Specific playing of the second video can be performed according to users' settings.

In an aspect, when the user is viewing the first video in the floating window, if the user finds a second video which he/she wants to view immediately and selects to play the second video, the selection of the second video needs to be monitored, and the content of the second video can be obtained. Then, the playing of the second video can be started. At this time, by sending the instruction for playing the second video, the floating window can be closed, and then the playing of the second video is conducted.

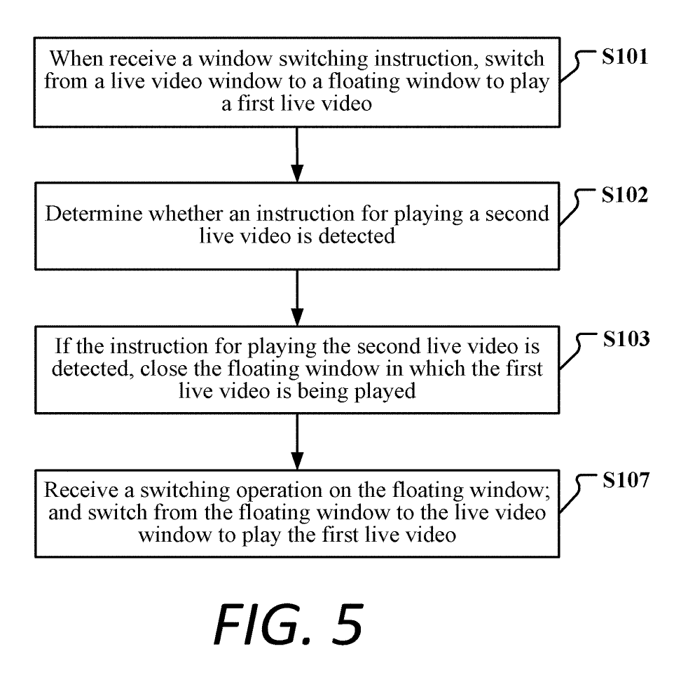

In an aspect, as shown in FIG. 5, the above method for playing video can further include the following steps.

In S107, switching operation on the floating window is received, and switching from the floating window to the video window is performed to play the first video.

During the playing of the first video, if the user clicks the floating window, the floating window is closed and the first video is played in the video window. That is, the user can close the floating window at any time by clicking or other switching manners, and thereby switch to the video window to view the video.

The above aspects of the present disclosure switch playing of a video to a floating window, and the playing of the video in the current floating window stops only if a user selects to play another video. Thus, while viewing the video in the floating window, the user can perform other operations unrelated to the video on a page outside the floating window, and thus user experience is greatly improved.

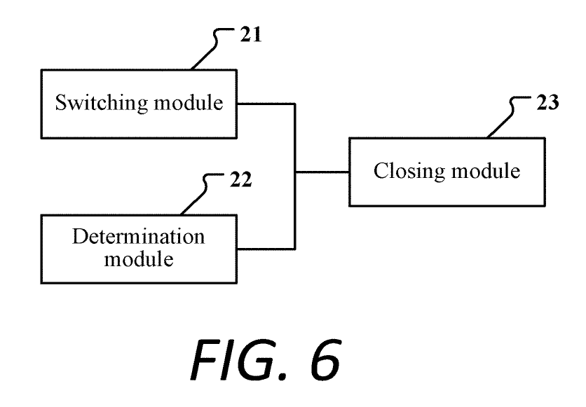

FIG. 6 is a block diagram of a device for playing videos according to an exemplary aspect. As shown in FIG. 6, the device can include a switching module 21, a determination module 22 and a closing module 23.

The switching module 21 is configured to, when a window switching instruction is received, switch from a video window to a floating window to play a first video.

The determination module 22 is configured to determine whether an instruction for playing a second video is detected.

The closing module 23 is configured to, on the condition that the instruction for playing the second video is detected, close the floating window in which the first video is being played.

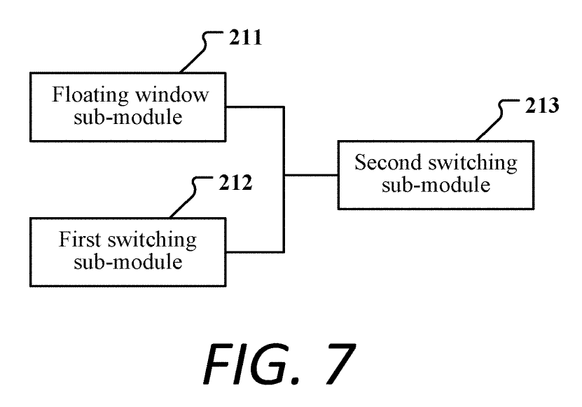

In an aspect, as shown in FIG. 7, the switching module 21 can include a floating window sub-module 211.

The floating window sub-module 211 is configured to set an area of the floating window as smaller than an area of the video window.

In an aspect, as shown in FIG. 7, the switching module 21 can include a first switching sub-module 212.

The first switching sub-module 212 is configured to receive a switching operation on the floating window, and switch from the floating window to the video window to play the first video.

In an aspect, as shown in FIG. 7, the switching module 21 can include a second switching sub-module 213.

The second switching sub-module 213 is configured to, when the window switching instruction is received, switch from the video window which is a full-screen window to the floating window to play the first video.

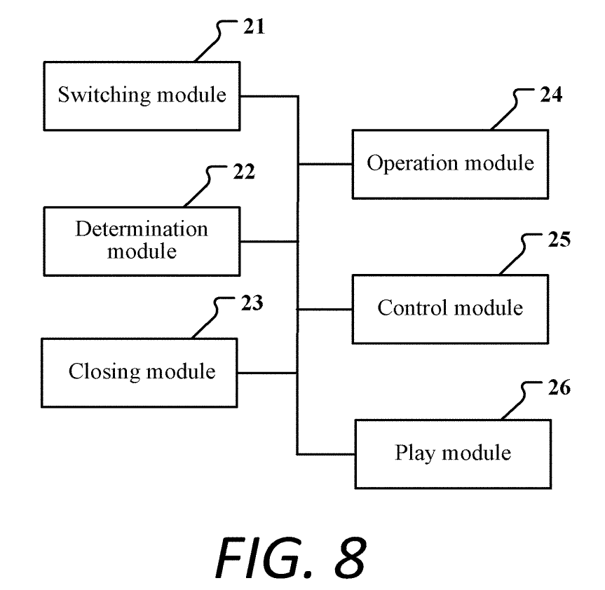

In an aspect, as shown in FIG. 8, the device can further include an operation module 24.

The operation module 24 is configured to set an operation interface on an area which is not covered by the floating window.

In an aspect, as shown in FIG. 8, the above device can further include a control module 25.

The control module 25 is configured to control the floating window to move within a preset area.

In an aspect, as shown in FIG. 8, the device can further include a play module 26.

The play module 26 is configured to play the second video in the video window.

The technical solutions of the present disclosure switch playing of a video to a floating window to play the video, and the playing of the video in the current floating window stops only if a user selects to play another video. Thus, while viewing the video in the floating window, the user can perform other operations unrelated to the video on a page outside the floating window, and thus user experience is greatly improved.

With respect to the devices in the above aspects, the specific manners for performing operations by individual modules have been described in detail in the aspects regarding the methods, which will not be elaborated herein.

An aspect of the present disclosure further provides a non-transitory computer-readable storage medium. When the instructions in the storage medium is performed by a processor of a terminal, the terminal can perform a method for playing videos, including: when receiving a window switching instruction, switching from a video window to a floating window to play a first video; determining whether an instruction for playing a second video is detected; and on the condition that the instruction for playing the second video is detected, closing the floating window in which the first video is being played.

An area of the floating window is smaller than an area of the video window.

The method further includes: setting an operation interface on an area which is not covered by the floating window.

The method further includes: controlling the floating window to move within a preset area.

After the floating window is closed, the method further includes: playing the second video in the video window.

The method further includes: receiving a switching operation on the floating window; and switching from the floating window to the video window to play the first video.

The video window is a full-screen video window. When the window switching instruction is received, playing of the first video is switched from the full-screen video window to the floating window.

An aspect of the present disclosure provides a device for playing videos, including: a processor; and a memory for storing instructions executable by the processor; wherein the processor is configured to: when receiving a window switching instruction, switch from a video window to a floating window to play a first video; determine whether an instruction for playing a second video is detected; and on the condition that the instruction for playing the second video is detected, close the floating window in which the first video is being played.

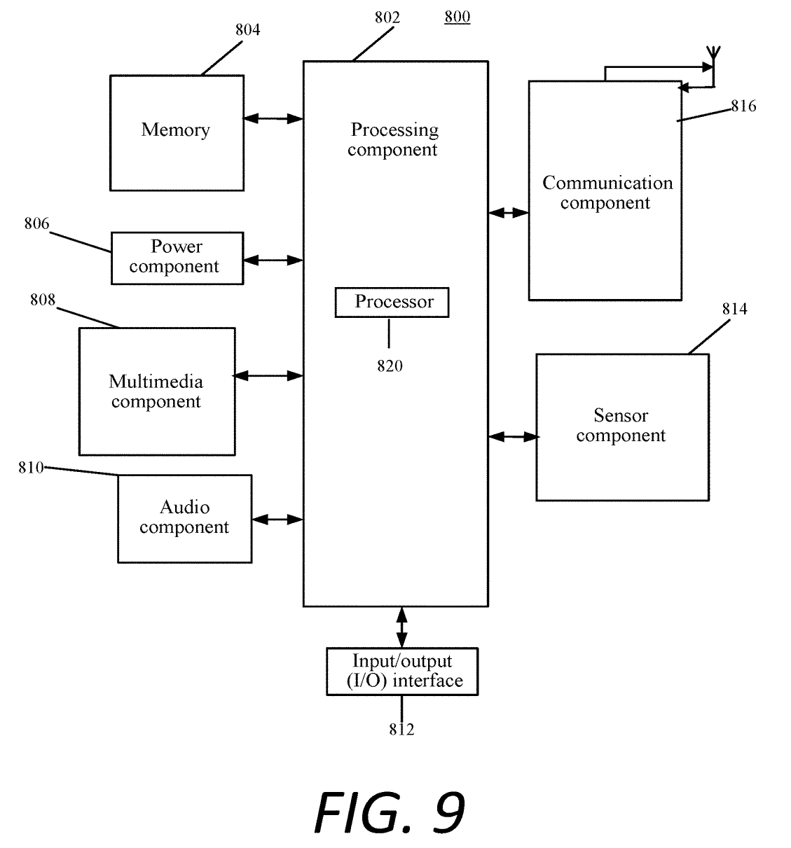

FIG. 9 is a block diagram of a device 800 for playing videos according to an exemplary aspect. For example, the device 800 may be a camera device such as a mobile phone having a camera function, a computer, a digital broadcast terminal, a messaging device, a gaming console, a tablet, a medical device, exercise equipment, a personal digital assistant, and the like.

Referring to FIG. 9, the device 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the device 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the device 800. Examples of such data include instructions for any applications or methods operated on the device 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the device 800. The power component 806 may include a power management system, one or more power sources, and any other components associated with the generation, management, and distribution of power in the device 800.

The multimedia component 808 includes a screen providing an output interface between the device 800 and the user. In some aspects, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some aspects, the multimedia component 808 includes a front camera and/or a rear camera. The front camera and the rear camera may receive an external multimedia datum while the device 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the device 800 is in an operation mode, such as a call mode, a recording mode, and a voice recognition mode. The received audio signal may be further stored in the memory 804 or transmitted via the communication component 816. In some aspects, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the device 800. For instance, the sensor component 814 may detect an open/closed status of the device 800, relative positioning of components, e.g., the display and the keypad, of the device 800, a change in position of the device 800 or a component of the device 800, a presence or absence of user contact with the device 800, an orientation or an acceleration/deceleration of the device 800, and a change in temperature of the device 800. The sensor component 814 may include a proximity sensor configured to detect the presence of nearby objects without any physical contact. The sensor component 814 may also include a light sensor, such as a CMOS or CCD image sensor, for use in imaging applications. In some aspects, the sensor component 814 may also include an accelerometer sensor, a gyroscope sensor, a magnetic sensor, a pressure sensor, or a temperature sensor.

The communication component 816 is configured to facilitate communication, wired or wirelessly, between the device 800 and other devices. The device 800 can access a wireless network based on a communication standard, such as WiFi, 2G, or 3G, or a combination thereof. In one exemplary aspect, the communication component 816 receives a broadcast signal or broadcast associated information from an external broadcast management system via a broadcast channel. In one exemplary aspect, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary aspects, the device 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary aspects, there is also provided a non-transitory computer-readable storage medium including instructions, such as the memory 804 including instructions executable by the processor 820 in the device 800, for performing the above-described methods. For example, the non-transitory computer-readable storage medium may be a ROM, a RAM, a CD-ROM, a magnetic tape, a floppy disc, an optical data storage device, and the like.

It is noted that the various modules, sub-modules, units, and components in the present disclosure can be implemented using any suitable technology. For example, a module may be implemented using circuitry, such as an integrated circuit (IC). As another example, a module may be implemented as a processing circuit executing software instructions.

Other aspects of the disclosure will be apparent to those skilled in the art from consideration of the specification and practice of the disclosure disclosed here. This disclosure is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure should only be limited by the appended claims.

What is claimed is:

1. A method for playing videos, comprising:
playing a first video in a video window;
receiving a first instruction to switch windows;
transferring the first video from the video window to a floating window in response to receiving the first instruction;
receiving a second instruction to play a second video; and
closing the floating window in response to receiving the second instruction.

2. The method of claim 1, wherein an area of the floating window is smaller than an area of the video window.

3. The method of claim 2, further comprising:
displaying an operation interface in an area that is not covered by the floating window.

4. The method of claim 1, further comprising:
moving the floating window within an area.

5. The method of claim 1, further comprising:
playing the second video in the video window after the floating window is closed.

6. The method of claim 1, further comprising:
receiving a switching operation on the floating window; and
transferring the first video from the floating window to the video window.

7. The method of claim 1, wherein the video window is a full-screen video window.

8. A device for playing videos, comprising:
a processor; and
a memory for storing instructions executable by the processor;
wherein the processor is configured to:
play a first video in a video window;
transfer the first video from the video window to a floating window in response to receiving the first instruction;
receive a second instruction to play a second video; and
close the floating window in response to receiving the second instruction.

9. The device of claim 8, wherein an area of the floating window is smaller than an area of the video window.

10. The device of claim 9, wherein the processor is further configured to:
display an operation interface in an area that is not covered by the floating window.

11. The device of claim 8, wherein the processor is further configured to:
move the floating window within an area.

12. The device of claim 8, wherein the processor is further configured to play the second video in the video window after the floating window is closed.

13. The device of claim 8, wherein the processor is further configured to:
receive a switching operation on the floating window; and
transfer the first video from the floating window to the video window.

14. The device of claim 8, wherein the video window is a full-screen video window.

15. A non-transitory computer-readable storage medium having stored therein instructions that, when executed by a processor of a terminal, cause the processor to perform a method for playing videos, the method comprising:
playing a first video in a video window;
transferring the first video from the video window to a floating window in response to receiving the first instruction;
receiving a second instruction to play a second video; and
closing the floating window in response to receiving the second instruction.
